(19) United States
(12) Patent Application Publication
(10) Pub. No.: US 2025/0155333 A1
(43) Pub. Date: May 15, 2025

(54) ANALYTIC SAMPLE TABLET CUTTER

(71) Applicant: Roy A. Stimits, Hampstead, NC (US)

(72) Inventor: Roy A. Stimits, Hampstead, NC (US)

(21) Appl. No.: 18/507,086

(22) Filed: Nov. 12, 2023

(51) Int. Cl. G01N 1/28; A61J 7/00

(52) U.S. Cl. CPC G01N 1/286; A61J 7/0007; G01N 2001/2873

(57) ABSTRACT

An analytic sample tablet cutter is formed from three separate components. A base includes a socket for a tablet cradle. One or more interchangeable tablet cradles may be inserted into the cradle socket of the base. A cutting lever is attached to the rear of the base by a hinge and houses a longitudinal blade in a socket on its bottom face. When the lever is rotated down onto the base, the flat bottom of the cutting lever lies flush against a boss surrounding the cradle sockets and fully encloses the tablet cradle. The blade of the cutting lever extends into a blade slot which bisects a channel holding a tablet. The blade channel does not extend above the top of the cradle. In addition, the channel has a transverse length longer than the tablet and nothing abuts either end of the tablet when it is in the cradle.

### BACKGROUND OF THE INVENTION

### Field of the Invention

The present invention relates to an analytic sample tablet cutter. More particularly, the invention relates to a device for splitting a tablet precisely within an enclosed chamber without impinging the ends of the tablet.

### Description of the Related Art

The use of tablets to administer medicine in solid form has become ubiquitous. A powder form from the medicine as well as various inactive ingredients, for example buffers, are tightly compressed to form a solid tablet, often in the shape of a capsule. Extensive testing is required to verify the components of tablets for regulatory approval and commercial use. To analyze the components of medicinal tablets, they must be broken down and dissolved into various solvents to perform chromatography, electrophoresis, spectroscopy and other testing methods.

To facilitate dissolution and solvents, a tablet must be broken up. A wide variety of tablet splitting devices are currently available. They are most typically designed for an end user to split a pill into smaller dosages. Many of these devices are unsuitable for cutting the hardest tablets. Furthermore, many of them are formed from materials that will break down and/or dissolve when exposed to solvents commonly used for testing medicinal tablets. These devices are also typically imprecise and can result in smaller pieces of the tablet breaking often becoming lost.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide a tablet cutter for breaking up tablets to prepare analytical samples for testing the composition of the tablet to ensure the product is safe and effective for consumers.

### BRIEF SUMMARY OF THE INVENTION

Disclosed is an analytic sample tablet cutter for splitting a tablet into two or more pieces in an enclosed space.

In one embodiment, an analytic sample tablet cutter has a base with a rectangular cradle socket surrounded by a rectangular boss extending upward from a top of the base. A tablet cradle is removably inserted into the rectangular socket in the base. A transverse tablet channel in the cradle is bisected by a longitudinal blade slot. The blade slot is deeper than the tablet channel. A cutting lever has a flat bottom face with a blade socket. The blade socket houses a downwardly extending longitudinal blade. The cutting lever is connected to the base by a hinge.

In another embodiment, the longitudinal blade extends into the blade slot a distance greater than the depth of the tablet channel. The flat bottom face of the cutting lever lies flush against the boss, thereby fully enclosing the tablet cradle within a rectanguloid chamber formed by the cradle socket and the blade socket.

In another embodiment, the tablet channel has a bottom that is flat along a transverse direction and curves upward along its front and rear sides. The bottom of the channel has a transverse axis of curvature located at least halfway down the depth of the tablet channel.

In another embodiment, the bottom of the tablet channel is above the height of the boss and the bottom of the blade slot is below the height of the boss, and the blade extends into the blade slot to a point below the height of the boss. The tablet cradle has an offset angle of between 10° and 25° relative to a vertical direction.

In another embodiment, a tablet is positioned in the tablet channel, and the tablet has a length less than a transverse length of the table channel and the tablet does not extend above a top of the tablet cradle.

It is therefore an object of the present invention to provide an analytic sample tablet cutter that bisects a tablet while not abutting or impinging on the ends of the tablet, and fully encloses the tablet during the cutting process. Another object is to provide an analytic tablet cutter capable of accommodating a plurality of interchangeable tablet cradles.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an analytic sample tablet cutter in a closed configuration in accordance with the principles of the invention;

FIG. 2 is a cross-sectional side view of an analytic sample cutter in a closed configuration in accordance with the principles of the invention;

FIG. 3 is a perspective view of a tablet cradle for an analytic sample cutter in accordance with principles of the invention;

FIG. 4 is a front plan view of a tablet cradle for an analytic sample cutter accordance with principles of the invention;

FIG. 5 is a side elevation view of a tablet cradle containing a tablet for an analytic sample cutter in accordance with principles of the invention;

FIG. 6 is a top plan view of a tablet cradle containing a tablet for an analytic sample cutter in accordance with principles of the invention;

FIG. 7 is a perspective view of a base for an analytic sample cutter in accordance with principles of the invention;

FIG. 8 is a top plan view of a base for an analytic sample cutter in accordance with principles of the invention;

FIG. 9 is a side elevation view of a base with an inserted tablet cradle for an analytic sample cutter in accordance with principles of the invention;

FIG. 10 is a rear elevation view of a base with an inserted tablet cradle for an analytic sample cutter in accordance with the principles of the invention;

FIG. 11 is a side elevation view of a cutting lever for an analytic sample cutter in accordance with principles of the invention;

FIG. 12 is a top plan view of a cutting lever for an analytic sample cutter in accordance with principles of the invention;

FIG. 13 is a bottom plan view of a cutting lever for an analytic sample cutter in accordance with principles of the invention;

FIG. 14 is a side cross-sectional view of an analytic sample cutter in a closed configuration in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices may be shown in block diagram form in order to facilitate describing the various embodiments herein.

Various embodiments of the disclosure could also include permutations of the various elements as if each dependent claim was a multiple dependent claim incorporating the limitations of each of the preceding dependent claims as well as the independent claims. Unless explicitly stated otherwise, such permutations are expressly within the scope of this disclosure. Similarly, the disclosure should be interpreted as including permutations of the various elements disclosed in the Figures, unless the various elements are clearly mutually exclusive.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise. As used herein, “longitudinal” refers to a direction perpendicular to the axis of rotation of the hinge, and “transverse” refers to a direction parallel to the hinge.

Disclosed is an analytic sample tablet cutter formed from three separate components. A base is configured to rest stably upon a flat surface and includes a socket for a tablet cradle. One or more interchangeable tablet cradles may be inserted into the cradle socket of the base. The tablet cradle secures the tablet for cutting. A cutting lever is attached to the rear of the base by a hinge and houses a longitudinal blade in a socket on its bottom face. When the lever is rotated down onto the base, the flat bottom of the cutting lever lies flush against a boss surrounding the cradle socket. This fully encloses the tablet cradle. The longitudinal blade of the cutting lever extends into a longitudinal blade slot which bisects a channel holding a tablet to be cut. The blade channel is sized such that the tablet lies completely within it and does not extend above the top of the cradle. In addition, the channel has a transverse length longer than the length of the tablet and nothing abuts either end of the tablet when it is in the cradle.

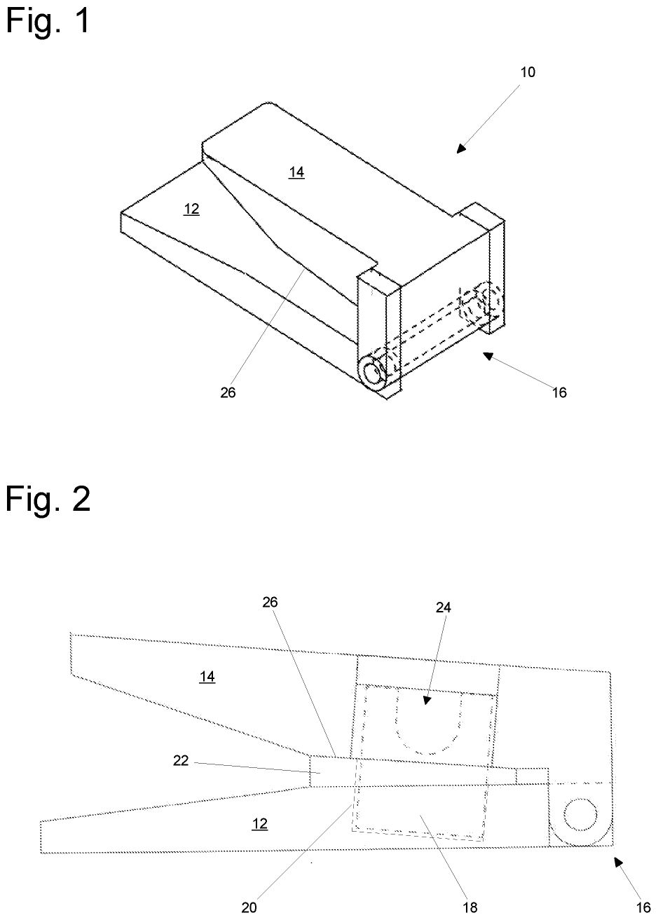

FIGS. 1 and 2 show an analytic sample tablet cutter 10 in accordance with the principles of the invention. The tablet cutter 10 is formed from three components: a base 12, a cutting lever 14 connected to the base 12 by a hinge 16, and a tablet cradle 18. The base 12 includes a cradle socket 20 surrounded by a flat, raised boss 22. In this embodiment, the socket 20 and boss 22 are angled slightly in the direction of the hinge 16. The cutting lever 14 includes a blade socket 24 sized to fit over the top of the tablet cradle 18 inside the cradle socket 20. The range of rotation of the cutting lever 14 relative to the base 12 is limited by the boss 22 to prevent undue stress on the hinge 16. When fully depressed, the lower face 26 of the cutting lever 14 lies flush against the planar top 21 of the boss 22. Those skilled in the art will appreciate that the use of a boss 22 abutting the lower face 26 allows substantial force to be applied to the cutting lever 14 without unduly stressing or straining the hinge 16.

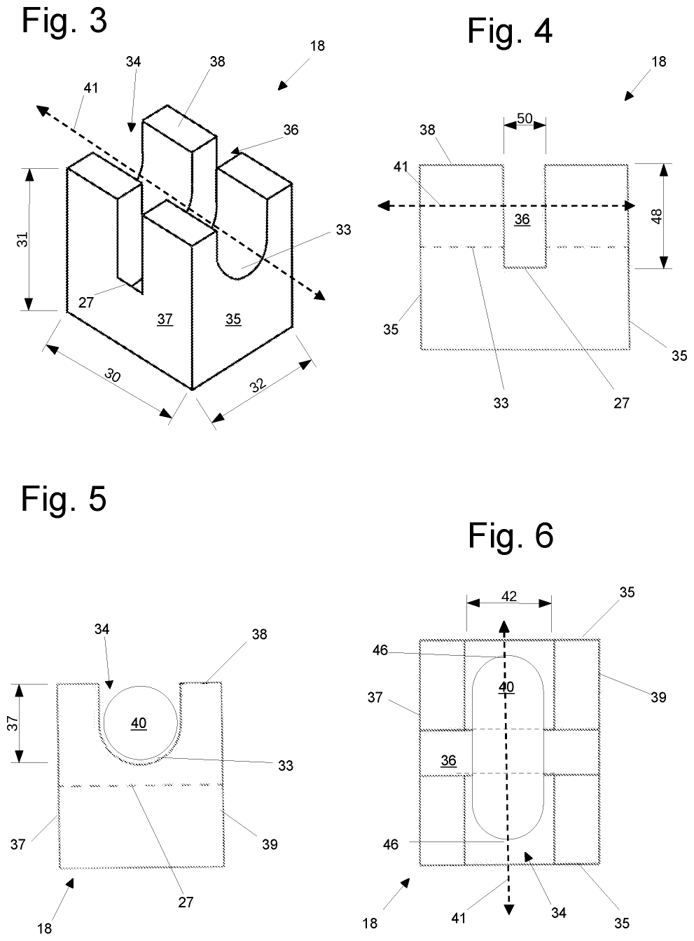

FIGS. 3-6 shows the tablet cradle 18. The rectanguloid tablet cradle 18 has a width 30, a length 32, and a height 31. The cradle 18 includes a tablet channel 34 bisected by a blade slot 36, both extending downward from the top 38 of the cradle 18. The tablet channel 34 has a depth 37, and the bottom 33 of the tablet channel 34 is curved in a half-cylinder shape. The bottom 33 is linear in a transverse direction between sides 35, and curves upward toward the front 37 and the rear 39. The cylindrical curvature of the bottom 33 has a transverse axial center of curvature 41 located at or below half of the depth 37 of the channel 34. The tablet channel 34 extends the entire width 30 of the cradle 18, open at each of the sides 35. The tablet channel 34 accommodates a capsule-shaped tablet 40 having a maximum width equal to or less than the width 42 of the tablet channel 34 and a length less than the width 30 of the cradle 18. Thus, the tablet 40 is always fully contained within the tablet channel 34 and does not protrude above the top 38 of the cradle 18. This configuration substantially reduces movement of the tablet 40 within the tablet channel 34. In addition, the tablet 40 has a length that is less than the width 30 of the cradle 18. Because nothing abuts the ends 46 of the tablet 40, there is no force, pressure or stress applied to the ends 46 tablet 40, which may counter any sideways forces generated by a blade cutting the tablet 40. As a result, the tablet 40 is more cleanly cut and crushing or crunching of the tablet 40 is minimized. The tablet channel 34 is open on each of the sides 35 of the cradle 18. Unlike a situation where a person is splitting a tablet to consume half of the tablet's dosage, preparation of an analytic sample of a tablet does not require precisely cutting the tablet in the exact middle. In this situation, it is not required to split a tablet precisely in half so the tablet cradle of the present invention, which has a tablet channel with a greater length than the length of the tablet is not undesirable. Tablets used for creating half dosages must ensure that the tablet is aligned properly and therefore typically includes structures at each end of the tablet to hold the tablet precisely in place to create half dosages. When a tablet is cut, the cutting process naturally imparts a force outward in the direction of each of the ends of the tablet. If a hard tablet is being held in place by structures at each of its ends, this resists the force of the blade, making cutting more difficult.

The blade slot 36 of the cradle 18 bisects the tablet channel 34 and extends the entire length 32 of the cradle 18. The slot 36 has a depth 48 which is greater than the depth 37 of the tablet channel 34. Thus, the bottom 27 of the blade slot 36 is lower than the bottom 33 of the tablet channel 34. This allows the edge of a blade to descend into the blade slot 36 to a point completely below the tablet, thus ensuring that the tablet 40 is completely cut. The blade slot 36 is substantially narrower than the tablet channel 34, and has a width 50 that is half or less than half of the width 42 of the tablet channel 34. Optionally, a sample tablet cutter 10 may include a plurality of interchangeable tablet cradles to accommodate tablets of different sizes and shapes. The blade slot 36 is open on both the front 37 and the back 39 of the cradle 18. The analytical sample cutter of the invention may include a plurality of interchangeable tablet cradles for use with tablets of different size.

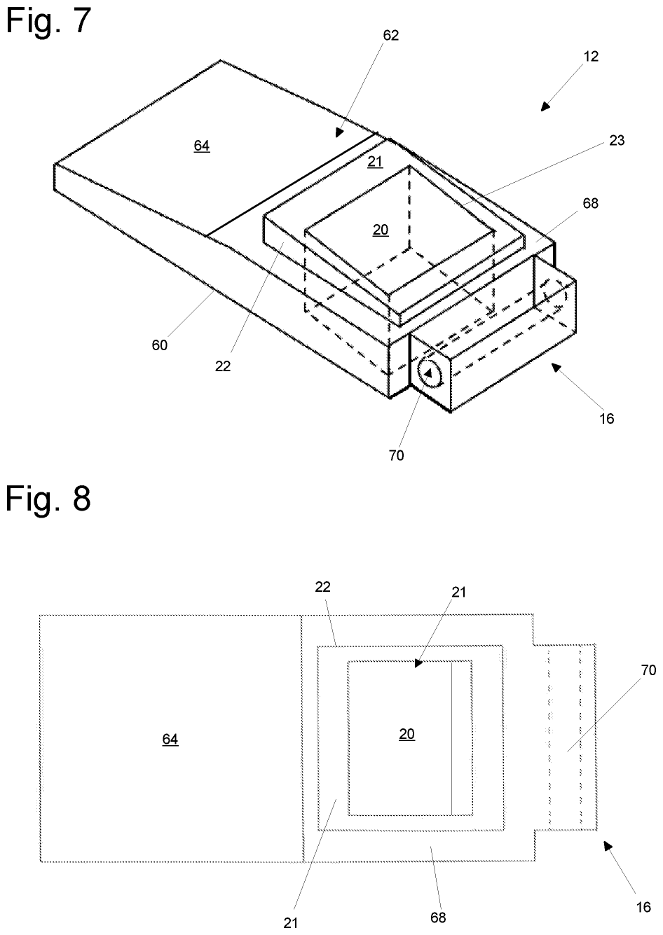

FIGS. 7 and 8 show the base 12 of the tablet cutter 10 in accordance with principles of the invention. The base 12 is rectangular and has a flat bottom 60 for stability and its top 62 has a downwardly tapering front region 64 and horizontal rear region 68 parallel to the bottom 60. The raised boss 22 is rectangular and surrounds an opening 23 into the cradle socket 20, which are located in the rear region 68 just forward of the hinge 16. In this embodiment, the hinge 16 is formed by a transverse bore 70 through the base 12 that accommodates a hinge pin about which the cutting lever 14 rotates. Both the boss 22 and the cradle socket 20 are offset at an angle of about 18°. Optionally, the boss 22 and cradle socket 20 may be offset of an angle between zero and 25° relative to the base 60 and rear region 68 of the top 62.

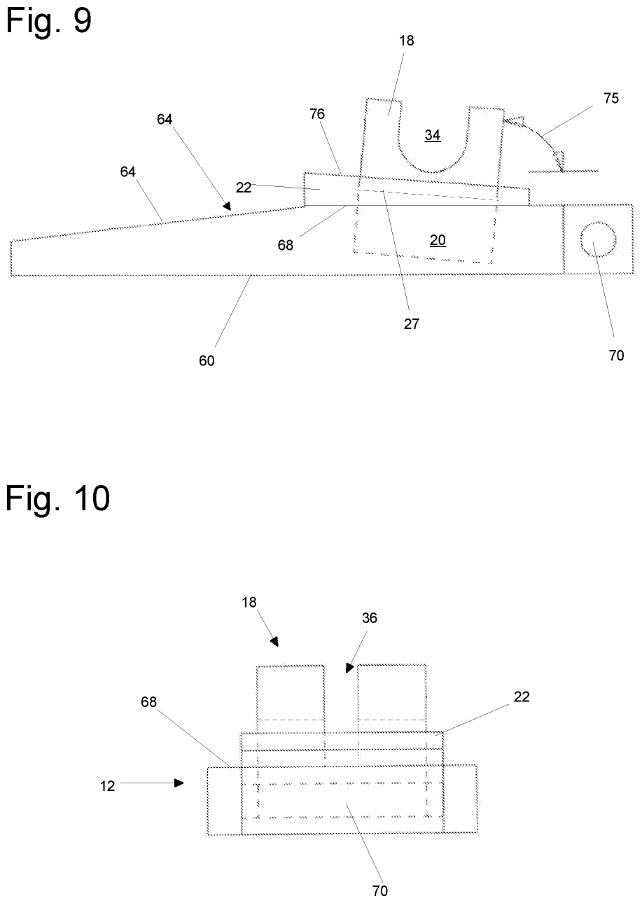

FIGS. 9 and 10 show the cradle 18 inserted into the socket 20, which extends upward from the socket 20 at an offset angle of about 18° relative to the vertical direction. Thus, the angle 75 between the cradle 18 and a horizontal surface is about 72°. The socket has a depth 37 (shown in FIG. 5) such that the bottom of the tablet channel 34 is above the top 76 of the boss 22 and the bottom 27 of the blade slot 36 is below the top 76 of the boss 22. Because the tablet channel 34 is above the top of the boss 22, the inner sides of the socket 20 cannot impinge upon or abuts a tablet placed within the tablet channel 34. As explained above, this improves the precision when cutting the tablet.

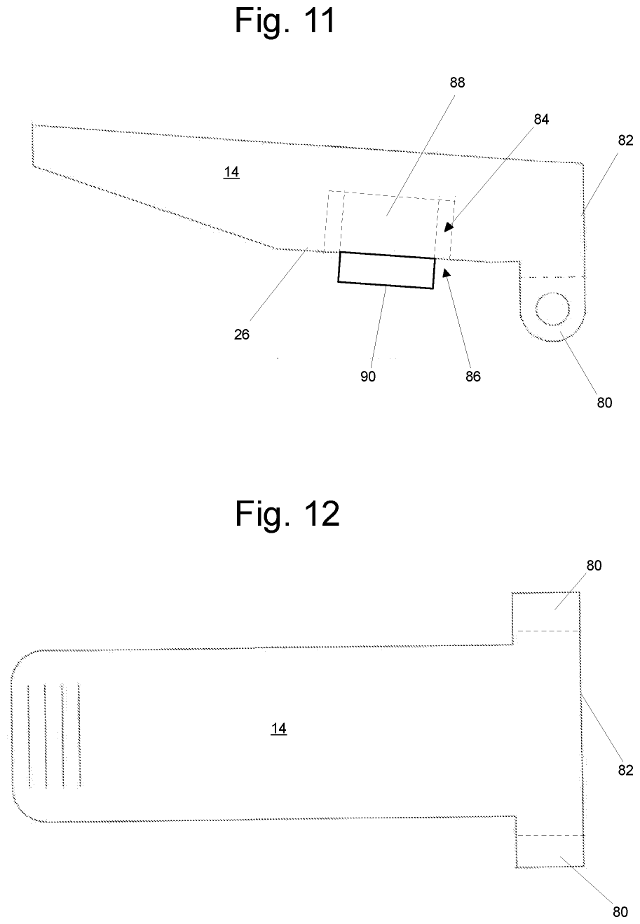

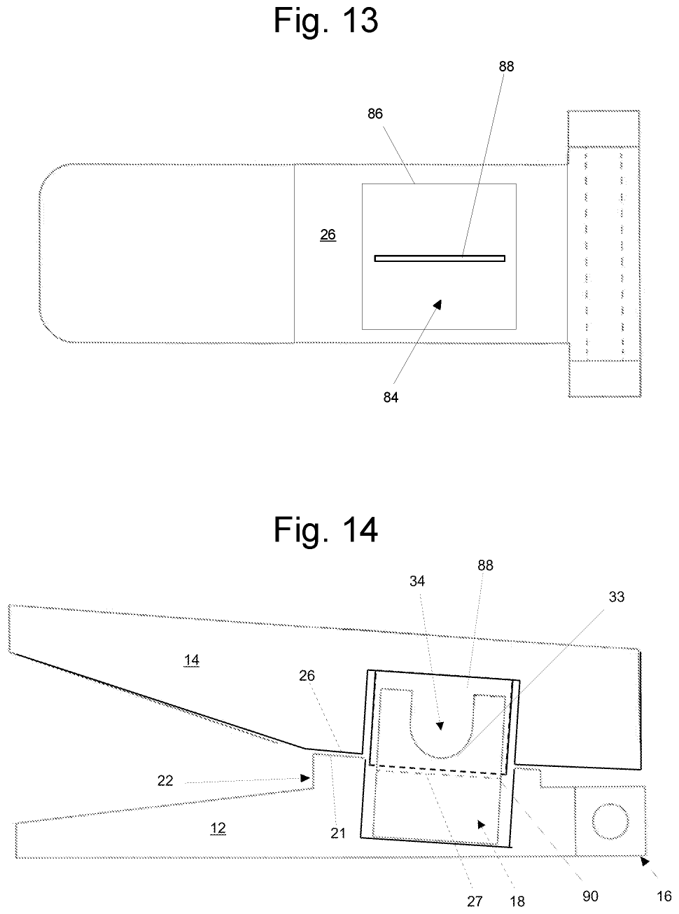

FIGS. 11-13 show the cutting lever 14. In this embodiment, the cutting lever 14 includes two opposing eyelets 80 at the bottom of its rear side 82 for attaching to a hinge pin to form a hinge 16 as shown above. The bottom face 26 of the cutting lever 14 has a rectangular blade socket 84 extending upward into the lever 14 through opening 86. The opening 86 and the blade socket 84 is sized to accommodate the upper portion of the tablet cradle 18 when the tablet cutter is in the closed configuration. The blade 88 extends downward along a longitudinal direction down the center of the blade socket 84 and partially protrudes from the blade socket 84 through the opening 86. The blade 88 is oriented such that when the cutting lever 14 is lowered and such that bottom face 26 abuts against the top 21 of the boss 22, the blade 88 extends into the blade slot 36 below the bottom 33 of the tablet channel 34.

FIG. 14 shows the analytic sample tablet cutter 10 in the closed position. The bottom face 26 of the lever 14 abuts the top 21 of the boss 22, thereby enclosing the tablet cradle 18. The bottom edge 90 of the blade 88 extends downward past the bottom 33 of the tablet channel 34 and almost touches the bottom 27 of the blade slot 36. Preferably, the blade 88 is positioned so that its edge 90 does not actually touch the bottom 27 of the blade slot 36 so that impinging on the bottom 27 does not unnecessarily degrade the sharpness of the edge 90. The bottom 33 of the tablet channel 34 is above the top 21 of the boss 22, while the blade edge 90 and the bottom of the blade slot 27 are both below the top 21 of the boss 22. The top 21 of the boss 22 has an offset angle relative to the horizontal direction equal to the offset angle of the tablet cradle relative to the vertical direction.

In use, a tablet cradle having a tablet channel suitably sized for a tablet to be cut is inserted into the cradle socket of the base so that the tablet channel is aligned transverse to the longitudinal direction of the blade and the blade slot. A suitably sized tablet channel for a particular tablet will have a length greater than the length of the tablet and will be large enough such that the tablet resides entirely within the tablet channel and does not protrude upward out of it. The tablet is placed within the tablet channel. The cutting lever is then translated into the closed configuration by rotating it about the hinge and pressed over the base until the bottom face of the lever lies flush with, abutting against, the top of the boss on the base. This causes the blade to enter the blade slot until the edge of the blade is below the bottom of the blade channel, thereby completely cutting a tablet within the tablet channel. The tablet, tablet cradle and blade are completely enclosed within the cradle socket and the blade socket. The cutting lever is then rotated upward to translated it into the open configuration at which time the cut tablet may be removed. The tablet cradle and optionally the blade, blade socket and cradle socket may be rinsed with solvent to capture any pieces of a tablet that broke loose during the cutting process.

The analytic sample tablet cutter of the invention is preferably comprised of a sturdy, durable material not prone to dissolution in various solvents. High density polyethylene is an example of a suitable plastic for use in constructing the invention. The blade itself may be a surgical blade formed from stainless steel or similar durable material. The blade may be replaced when necessary.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. That is, the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. The descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. An analytic sample tablet cutter comprising:
a base having a rectangular cradle socket surrounded by a rectangular boss extending upward from a top of the base;
a tablet cradle removably inserted into the rectangular socket in the base, having a transverse tablet channel and a longitudinal blade slot bisecting the tablet cradle, the blade slot having a depth greater than a depth of the tablet channel;
a cutting lever having a flat bottom face and a blade socket in the flat bottom face, said blade socket housing a longitudinal blade; and,
a hinge rotatably connecting a bottom rear region of the cutting lever to a rear region of the base;
wherein when the cutting lever is rotated about the hinge to a closed configuration, the longitudinal blade extends into the blade slot a distance greater than the depth of the tablet channel, and flat bottom face of the cutting lever lies flush against the boss thereby fully enclosing the tablet cradle within a rectanguloid chamber formed by the cradle socket and the blade socket.

2. The analytic sample tablet cutter of claim 1 wherein the tablet channel has a bottom that is flat along a transverse direction and curves upward along its front and rear sides, the bottom having a transverse axis of curvature located at least halfway down the depth of the tablet channel.

3. The analytic sample tablet cutter of claim 2 wherein, when the tablet cradle is inserted into the cradle socket, the bottom of the tablet channel is above the height of the boss and the bottom of the blade slot is below the height of the boss, and the blade extends into the blade slot to a point below the height of the boss.

4. The analytic sample tablet cutter of claim 3 wherein the tablet cradle has an offset angle of between 10° and 25° relative to a vertical direction.

5. The analytic sample tablet cutter of claim 4 wherein a tablet is positioned in the tablet channel, and the tablet has a length less than a transverse length of the table channel and the tablet does not extend above a top of the tablet cradle.
